(19) United States
(12) Patent Application Publication
(10) Pub. No.: US 2016/0236257 A1
(43) Pub. Date: Aug. 18, 2016

(54) DUCT FLANGE STRUCTURE, AND MANUFACTURING METHOD FOR THE SAME

(71) Applicant: SHINFUJI KUUCHOU CO., LTD., Kounosu-shi (JP)

(72) Inventors: Isamu KAJINO, Kounosu-shi (JP); Naoki HASHIMOTO, Kounosu-shi (JP); Tomotsugu NOGUCHI, Kounosu-shi (JP); Takaaki UCHIKAWA, Kashiwa-shi (JP)

(21) Appl. No.: 14/944,144

(22) Filed: Nov. 17, 2015

(30) Foreign Application Priority Data
Feb. 17, 2015 (JP) 2015-28387

(51) Int. Cl. B21D 19/00; F16L 23/02

(52) U.S. Cl. CPC B21D 19/00; F16L 23/02

(57) ABSTRACT

[Problems] To provide a duct flange structure which has a higher strength and which is easier to handle and manufacture.

[Means for solving the Problems] A duct flange structure which is arranged in an end portion of a cylindrical duct body 2 having a substantially quadrilateral shape in section, includes: a flange portion 4 formed by bending an extension portion 30 extending from an opening edge 3A of each of wall plates 3 constituting the duct body 2, the flange portion 4 being constituted by a vertical portion 41 extending outside substantially vertically to the wall plate 3 and a horizontal portion 42 extending substantially parallel to the wall plate 3 from the vertical portion 41, the vertical portion 41 and the horizontal portion 42 being formed by folding and superposing the extension portion 30 in two or more.

### TECHNICAL FIELD

The present invention relates to a duct flange structure which is arranged in an end portion of a duct body of a duct and connects the duct with another duct or the like, and a manufacturing method for the duct flange structure.

### BACKGROUND ART

A cylindrical duct body having a substantially quadrilateral shape in section is provided at an opening end thereof with a flange extending along the opening edge for connecting the duct to another duct or the like. Specifically, a common-plate flange is formed by bending an end portion of each of steel plates constituting a duct body, then the surfaces of two such flanges are joined together and those flanges are held by means of flange-holding metal fittings (clips). In the corners of the flanges, corner pieces are provided and the flanges are fastened there with bolts, thereby connecting the two ducts and the like (e.g., refer to Non-Patent Document 1).

There is, for example, a smoke-extraction duct for extracting smoke at the outbreak of a fire. This duct takes in air having a higher pressure than an ordinary duct does (e.g., threefold). Hence, the smoke-extraction duct requires a flange having a higher strength and rigidity, and the flange is formed by an angle material. Specifically, the flange is formed by connecting an angle material (angle steel) having a substantially L-shape in section to an opening end portion of a duct body by means of riveting or welding. The flange is formed with bolt insertion holes at predetermined intervals. Two such flanges are fastened by joining the surfaces of those flanges together and inserting bolts into the bolt insertion holes, thereby making the connection of the two ducts or the like (e.g., refer to Non-Patent Document 2). Besides, the angle material forming the flange is subjected to a coating, thereby inhibiting corrosion of the angle material.

### PRIOR ART DOCUMENTS

### Patent Document

[Non-Patent Document 1] pp. 39-40 of “Standard Duct Text” edited and issued in July 2013 by National Duct Manufacturers Association as general incorporated association

[Non-Patent Document 2] p. 37 of “Standard Duct Text” edited and issued in July 2013 by National Duct Manufacturers Association as general incorporated association

### SUMMARY OF THE INVENTION

### Problems to be Solved by the Invention

An angle material is thicker and heavier than a steel plate forming a duct body, thereby raising the total weight of a smoke-extraction duct. This makes it hard to handle the duct, for example, to carry or install the duct. Further, angle materials need employing in addition to steel plates constituting a duct body, thereby raising the cost of duct components and requiring welding or coating work. As a result, a great deal of cost and labor are necessary for manufacturing the duct. Still further, welding or coating worsens the manufacturing work environment, thereby imposing a heavy burden on manufacturing workers.

Therefore, it is an object of the present invention to provide a duct flange structure which has a higher strength and which is easier to handle and manufacture, and a manufacturing method for the duct flange structure.

### Means for solving the Problem

In order to accomplish the object, a duct flange structure according to claim 1 which is arranged in an end portion of a cylindrical duct body having a substantially quadrilateral shape in section, comprises: a flange portion formed by bending an extension portion extending from an opening edge of each of wall plates constituting the duct body, the flange portion being constituted by a vertical portion extending outside substantially vertically to the wall plate and a horizontal portion extending substantially parallel to the wall plate from the vertical portion, the vertical portion and the horizontal portion being formed by folding and superposing the extension portion in two or more.

According to claim 2, in the duct flange structure of claim 1, the extension portion extends toward the opening edge of the wall plate and is folded and superposed.

According to claim 3, in the duct flange structure of claim 1 or 2, the vertical portion is formed with a bolt insertion hole for inserting a bolt into the vertical portion.

According to claim 4, in the duct flange structure of claims 1 to 3, the edge of the extension portion is inside of the duct body.

According to claim 5, a manufacturing method for the duct flange structure according to any one of claims 1 to 4, comprises the steps of: folding and superposing the extension portion in two or more to form a superposition portion; and bending the superposition portion to form the vertical portion and the horizontal portion.

### Advantages of the Invention

In the duct flange structure of claim 1, the flange portion constituted by the vertical portion and the horizontal portion is formed by folding and superposing the extension portion of the wall plate in two or more. Therefore, the flange portion has a higher strength and rigidity, and hence, the flange portion is applicable to a smoke-extraction duct and the like. Further, the vertical portion and the horizontal portion are formed by the extension portion of the wall plate, in other words, by a steel plate or the like having the same thickness as the duct body, thereby lightening the total weight of the duct. This makes it easier to handle the duct, for example, to carry or install the duct.

Moreover, the wall plate is lengthened to form the extension portion, thereby dispensing with angle materials or the like, apart from steel plates or the like constituting the duct body, and hence lowering the cost of duct components. Further, welding or coating is dispensable and bending work for the extension portion is only needed, thereby lessening the cost and labor for manufacturing the duct. Still further, welding or coating is not conducted, and hence, the manufacturing work environment is kept better, thereby reducing the burden on manufacturing workers.

In the duct flange structure of claim 2, the extension portion extends toward the opening edge of the wall plate and is folded and superposed. Therefore, the wall plate becomes stronger and more rigid on the opening-edge side thereof, in other words, the flange portion becomes stronger and more rigid on the root side thereof, thereby enhancing the strength and rigidity of the flange portion.

In the duct flange structure of claim 3, the vertical portion is formed with the bolt insertion hole. Therefore, two such flanges can be fastened by inserting a bolt into the bolt insertion holes. Accordingly, the flanges are more strongly connected, thereby preventing the duct from falling off.

In the duct flange structure of claim 4, the edge of the extension portion is inside of the duct body. Therefore, the edge of the extension portion is invisible from the outside, and hence, the external appearance becomes better. Besides, workers can be prevented from touching the edge of the extension portion to sustain injuries or the like.

In the manufacturing method for the duct flange structure of claim 5, the extension portion is folded and superposed in two or more to form a superposition portion, and thereafter, the vertical portion and the horizontal portion are formed. In other words, there is no need to repeatedly form and superpose the vertical portion and the horizontal portion. Therefore, the vertical portion and the horizontal portion corresponding to the superposition of the extension portion can be more easily and properly formed, so that the flange can be manufactured more easily and at a lower cost.

### BRIEF DESCRIPTION OF THE DRAWINGS

FIG. 1 is a sectional view (an A-A sectional view of FIG. 3) of a duct flange structure according to an embodiment of the present invention.

FIG. 2 is a sectional view of a superposition portion in a manufacturing process of the duct flange structure of FIG. 1.

FIG. 3 is a perspective partial view of a duct provided with the duct flange structure of FIG. 1.

### MODE FOR IMPLEMENTING THE INVENTION

An embodiment of the present invention will be below described with reference to the drawings.

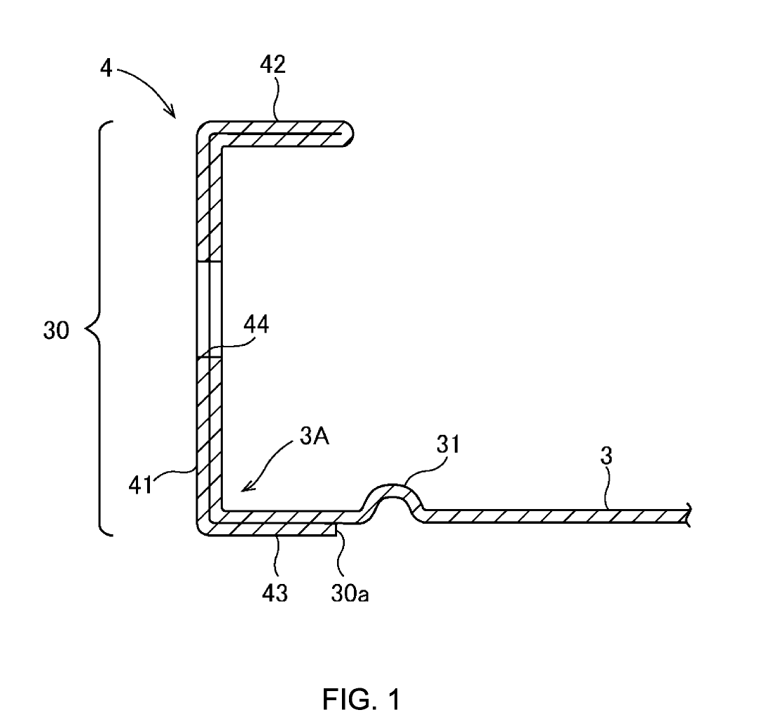

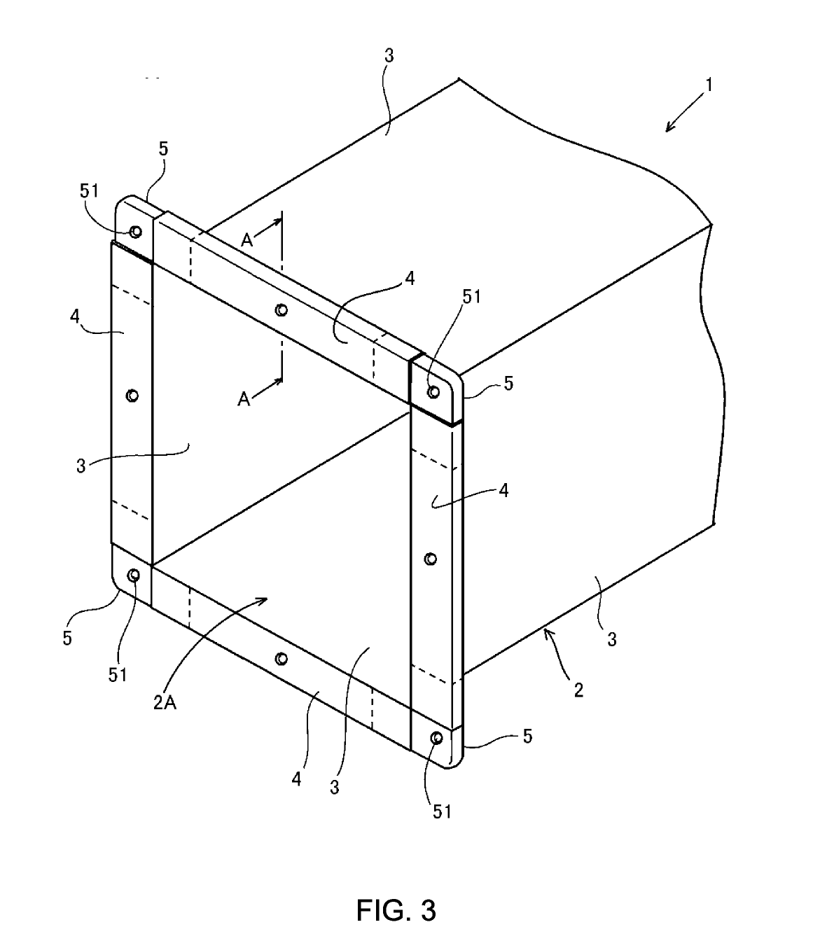

FIGS. 1 to 3 show the embodiment of the present invention. FIG. 3 is a perspective view of a duct 1 provided with a duct flange structure according to the embodiment. The duct flange structure is a flange structure which is arranged in an opening end portion 2A of a duct body 2 and which connects the duct 1 to another duct or the like.

The duct body 2 is a cylindrical body having a substantially quadrilateral shape in section and is constituted by four wall plates 3 each of which is a corrosion-resisting steel plate. Specifically, the duct body 2 is formed by arranging the substantially rectangular wall plates 3 in a quadrilateral barrel shape and joining the side edges of the adjoining wall plates 3. The joint portion of the two wall plates 3 may be fixed, or alternatively, the wall plates 3 may be freely pivoted on the joint portion (the duct body 2 may be freely folded up).

In the duct body 2, a ring-shaped flange is formed in at least one opening end portion 2A. Specifically, a flange portion 4 is formed in the opening end portion 2A of each wall plate 3, and the four flange portions 4 are arranged in a rectangular ring shape to forma flange. Between the end parts of the adjoining flange portions 4, in other words, in the four corners of the opening end portion 2A of the duct body 2, a corner piece 5 is provided respectively, and the corner piece 5 is an L-shaped flat plate. The corner piece 5 is formed in the corner thereof with a corner bolt insertion hole 51 for inserting a bolt.

Each flange portion 4 is formed by bending an extension portion 30 extending from an opening edge 3A of the wall plate 3 and is constituted by a vertical portion 41 extending outside substantially vertically to the wall plate 3 and a horizontal portion 42 extending substantially parallel to the wall plate 3 from the vertical portion 41. In other words, the extension portion 30 corresponds to the part of the steel plate which extends from the opening edge 3A of the wall plate 3 located in the opening end portion 2A of the duct body 2. The extension portion 30 is bent into the vertical portion 41 and the horizontal portion 42. The vertical portion 41 extends substantially vertically to the wall plate 3 in the direction opposite to the inside of the duct body 2 (in the outside direction). The horizontal portion 42 extends substantially parallel to the wall plate 3 from the free-end part (the part opposite to the wall plate 3) of the vertical portion 41. Hence, the flange portion 4 unites with the wall plate 3 and extends over the full length of the opening edge 3A of the wall plate 3.

The vertical portion 41 and the horizontal portion 42 are formed by folding and superposing the extension portion 30 in two or more. In this embodiment, the vertical portion 41 and the horizontal portion 42 are formed by folding and superposing the steel plate as the extension portion 30 in two. The vertical portion 41 is a connection surface part coming into contact with a flange of another duct or the like and has a height connectable with a flange of another duct or the like. The horizontal portion 42 is bent toward the vertical portion 41 and is a fixation part for fixing the corner piece 5. The horizontal portion 42 has a length suitable when being bent for holding and fixing the corner piece 5 between the horizontal portion 42 and the vertical portion 41.

The extension portion 30 extends toward the opening edge 3A of the wall plate 3 and is folded and superposed. Specifically, the free-end part of the extension portion 30 extends from the opening edge 3A toward the middle of the wall plate 3 and is superposed on the wall plate 3. This superposition part (second horizontal portion 43) is designed to have a length enough to give the second horizontal portion 43 as the root of the flange portion 4 a specified bending strength and the like.

An edge 30a of the extension portion 30 is located inside of the duct body 2. Specifically, the extension portion 30 is bent to position the free-end part of the extension portion 30 on the internal-surface side of the wall plate 3 (on the inside of the duct body 2). Accordingly, the edge 30a of the free-end part of the extension portion 30 is inside of the duct body 2.

The vertical portion 41 is formed with a bolt insertion hole 44 for inserting a bolt into the vertical portion 41. The diameter of the bolt insertion hole 44 and the number of the bolt insertion holes 44, or the diameter of a bolt and the number of bolts, are designed on the basis of the size or weight of the duct body 2, the length of the flange portion 4 and the like so that the duct has a specified connection strength. Near the second horizontal portion 43, the wall plate 3 is formed with a rib portion 31 protruding outside, so that the corner piece 5 can be held and fixed between the rib portion 31 and the vertical portion 41.

Next, a description will be given about a manufacturing method for the flange portion 4 (the duct flange structure).

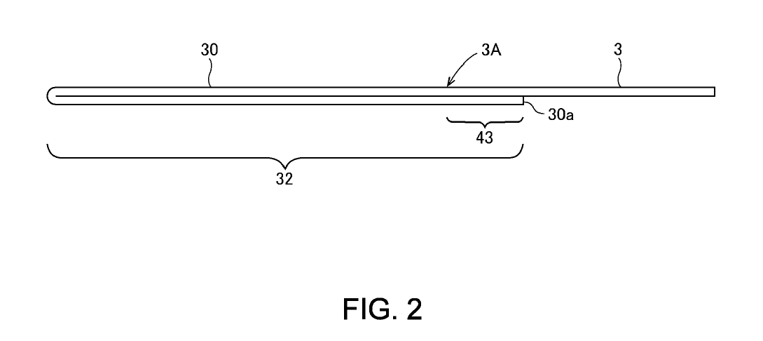

First, as shown in FIG. 2, the extension portion 30 equivalent to the steel plate extending from the opening edge 3A of the wall plate 3 is folded and superposed in two to forma superposition portion 32. In FIG. 2, the extension portion 30 ranges from the opening edge 3A up to the edge 30a, and the extension portion 30 is designed to have a length enough to form the vertical portion 41, the horizontal portion 42 and the second horizontal portion 43. In order to form the second horizontal portion 43, the free-end part of the extension portion 30 is brought toward the wall plate 3 from the opening edge 3A, and the extension portion 30 is folded and superposed in two.

Thereafter, the superposition portion 32 is formed at a predetermined position thereof with the bolt insertion hole 44, and sequentially, the superposition portion 32 is bent into the vertical portion 41 and the horizontal portion 42. Specifically, the superposition portion 32 on the free-end side (the opposite side to the wall plate 3) thereof is substantially vertically bent to form the horizontal portion 42. Then, the superposition portion 32 is substantially vertically bent along the opening edge 3A (the position where the opening edge 3A is to be formed) to form the vertical portion 41. In this process, the horizontal portion 42 may be formed after the vertical portion 41 has been formed, or alternatively, the vertical portion 41 may be formed after the horizontal portion 42 has been formed. In the case where the wall plates 3 are joined together by side seaming, the wall plates 3 are formed along the side edges with a seam, and the seam may be formed after the vertical portion 41 and the horizontal portion 42 have been formed, or alternatively, before the vertical portion 41 and the horizontal portion 42 are formed.

As described so far, in the duct flange structure, the flange portion 4 constituted by the vertical portion 41 and the horizontal portion 42 is formed by folding and superposing the extension portion 30 of the wall plate 3 in two. Therefore, the flange portion 4 has a higher strength and rigidity, and hence, the flange portion 4 is applicable to a smoke-extraction duct and the like. Further, the vertical portion 41 and the horizontal portion 42 are formed by the extension portion 30 of the wall plate 3, in other words, by a steel plate having the same thickness as the duct body 2, thereby lightening the total weight of the duct 1. This makes it easier to handle the duct 1, for example, to carry or install the duct 1.

Moreover, the wall plate 3 is lengthened to form the extension portion 30, thereby dispensing with angle materials or the like, apart from steel plates constituting the duct body 2, and hence lowering the cost of duct components. Further, welding or coating is dispensable and bending work for the extension portion 30 is only needed, thereby lessening the cost and labor for manufacturing the duct 1. Still further, welding or coating is not conducted, and hence, the manufacturing work environment is kept better, thereby reducing the burden on manufacturing workers.

In addition, the extension portion 30 extends toward the opening edge 3A of the wall plate 3 and is folded and superposed, and the second horizontal portion 43 is formed. Therefore, the wall plate 3 becomes stronger and more rigid on the side of the opening edge 3A, in other words, the flange portion 4 becomes stronger and more rigid on the root side thereof, thereby enhancing the strength and rigidity of the flange portion 4.

Furthermore, the vertical portion 41 is formed with the bolt insertion hole 44. Therefore, two such flanges can be fastened by inserting a bolt into the bolt insertion holes 44. Accordingly, the flanges are more strongly connected, thereby preventing the duct 1 from falling off.

Moreover, the edge 30a of the extension portion 30 is inside of the duct body 2. Therefore, the edge 30a of the extension portion 30 is invisible from the outside, and hence, the external appearance becomes better. Besides, workers can be prevented from touching the edge 30a of the extension portion 30 to sustain injuries or the like.

Furthermore, in the above manufacturing method for the flange portion 4, the extension portion 30 is folded and superposed in two to form the superposition portion 32, and thereafter, the vertical portion 41 and the horizontal portion 42 are formed. In other words, there is no need to repeatedly form the vertical portion 41 and the horizontal portion 42 and superpose one on top of another. Therefore, the vertical portion 41 and the horizontal portion 42 corresponding to the superposition of the extension portion 30 can be more easily and properly formed, so that the flange can be manufactured more easily and at a lower cost.

Although the embodiment of the present invention has been above described, the present invention is not limited to the embodiment as a specific configuration thereof. Without departing from the scope of the present invention, variations or the like in design should be included in the present invention. For example, in the above embodiment, the steel plate (the extension portion 30) of the vertical portion 41, the horizontal portion 42 and the second horizontal portion 43 is folded and superposed in two. However, the steel plate may be folded and superposed in three or more in accordance with the thickness of the steel plate, the strength required for the flange or the like.

Moreover, the edge 30a of the extension portion 30 is arranged on the side of the internal surface of the wall plate 3 (inside of the duct body 2). However, the edge 30a of the extension portion 30 may be arranged on the side of the external surface (connection surface) of the vertical portion 41. This also prevents the edge 30a from being visible from the outside when the duct 1 is set in an installation place after connected to other ducts and the like.

### DESCRIPTION OF THE SYMBOLS

1 duct
2 duct body
2A opening end portion (end portion)
3 wall plate
3A opening edge
30 extension portion
30a edge
32 superposition portion
4 flange portion
41 vertical portion
42 horizontal portion
43 second horizontal portion
44 bolt insertion hole
5 corner piece

1. A duct flange structure which is arranged in an end portion of a cylindrical duct body having a substantially quadrilateral shape in section, comprising:
a flange portion formed by bending an extension portion extending from an opening edge of each of wall plates constituting the duct body, the flange portion being constituted by a vertical portion extending outside substantially vertically to the wall plate and a horizontal portion extending substantially parallel to the wall plate from the vertical portion,
the vertical portion and the horizontal portion being formed by folding and superposing the extension portion in two or more.

2. The duct flange structure according to claim 1, wherein the extension portion extends toward the opening edge of the wall plate and is folded and superposed.

3. The duct flange structure according to claim 1, wherein the vertical portion is formed with a bolt insertion hole for inserting a bolt into the vertical portion.

4. The duct flange structure according to claim 1, wherein the edge of the extension portion is inside of the duct body.

5. A manufacturing method for the duct flange structure according to claim 1, comprising the steps of:
folding and superposing the extension portion in two or more to form a superposition portion; and
bending the superposition portion to form the vertical portion and the horizontal portion.
